(19) United States
(12) Patent Application Publication
(10) Pub. No.: US 2009/0059023 A1
(43) Pub. Date: Mar. 5, 2009

(54) IMAGE PICKUP APPARATUS, LENS UNIT AND FACE DETECTION METHOD

(75) Inventor: Futoshi Sasaki, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/183,342

(22) Filed: Jul. 31, 2008

(30) Foreign Application Priority Data
Sep. 5, 2007 (JP) 2007-230404

(51) Int. Cl. H04N 5/228; G06K 9/00; H04N 5/232

(52) U.S. Cl. 348/222.1; 382/118; 348/345; 348/E05.042; 348/E05.031

(57) ABSTRACT

An image pickup apparatus includes a face detection unit configured to detect a face portion of an object in image data obtained by moving the focus lens to a plurality of movement positions, and a changing unit configured to change a movement position where the focus lens is located when image data to be subjected to face detection processing using the face detection unit is obtained in accordance with a change of a depth of field.

### BACKGROUND OF THE INVENTION

1. Field of the Invention

The present invention relates to image pickup apparatuses, and particularly relates to an image pickup apparatus including a unit used to detect a face portion of a person as an object.

2. Description of the Related Art

In general, image pickup apparatuses such as digital still cameras include various functions of preventing failure in photographing. An example of such a function includes an autofocus function of automatically focusing an object to be photographed so that an image is obtained with high quality.

Furthermore, another autofocus function of detecting a face portion of a person to be object by image recognizing processing and focusing the detected face portion so that the person is appropriately focused has been proposed.

In recent years, various techniques of detecting a face portion of a person have been proposed. Examples of such a technique include a method for detecting a face region by converting photometry data into hue and saturation, and generating and analyzing a two-dimensional histogram using the hue and saturation, and a method for detecting a face region by extracting a face candidate region corresponding to a face shape of a person and using feature information of the face candidate region.

However, in these face detection techniques, in a case where a captured image to be subjected to the image recognizing processing is in a blur state, accuracy of face detection is deteriorated, and therefore, the autofocus function of automatically focusing the face region is not effectively performed.

To address this disadvantage, Japanese Patent Laid-Open No. 2007-10898 discloses a method for performing image recognizing operation after a focus lens of a photographing lens unit is moved to a predetermined position so that panning and focusing processing is performed. By this, a position of a region corresponding to a face of an object is detected, and then, autofocus processing is performed so that the detected face region is focused.

However, in a case where a depth of field of the photographing lens is small, when only the technique proposed in Japanese Patent Laid-Open No. 2007-10898 in which the focus lens is moved to the predetermined position so that the panning and focusing processing is performed is used, the face detection may not be performed in an entire distance range from a closest end to an infinite end which can be focused. Therefore, a face of a person to be photographed may not be detected and the person may not be focused.

### SUMMARY OF THE INVENTION

According to an aspect of the present invention, there is provided an image pickup apparatus which obtains image data corresponding to an image formed using an imaging optical system including a focus lens. The image pickup apparatus includes a face detection unit configured to detect a face portion of an object in image data obtained by moving the focus lens to a plurality of movement positions, and a changing unit configured to change a movement position where the focus lens is located when image data to be subjected to face detection processing using the face detection unit is obtained in accordance with a change of a depth of field.

Other aspects and features of the present invention will become apparent from the following description and the attached drawings.

### BRIEF DESCRIPTION OF THE DRAWINGS

FIG. 1 is a block diagram illustrating an example configuration of a digital still camera including replaceable lens according to a first exemplary embodiment of the present invention.

FIG. 2 is a flowchart illustrating an example operation of a system control circuit when obtaining a lens information item from a lens unit.

FIG. 3 is a flowchart illustrating example operation of face detection processing.

FIGS. 4A to 4L are diagrams illustrating results of the face detection processing obtained in accordance with a depth of field.

FIG. 5 is a diagram illustrating a lens information item of a telephoto lens.

FIG. 6 is a table illustrating the relationship between movement position information items and various lenses.

FIG. 7 is a flowchart illustrating an example change of a state of a face detection mode in accordance with a focal length of the lens unit.

FIG. 8 is a block diagram illustrating an example configuration of a lens-integrated digital still camera according to a second exemplary embodiment of the present invention.

FIG. 9 is a table illustrating movement position information items in accordance with focal lengths and aperture values.

### DESCRIPTION OF THE EXEMPLARY EMBODIMENTS

### First Exemplary Embodiment

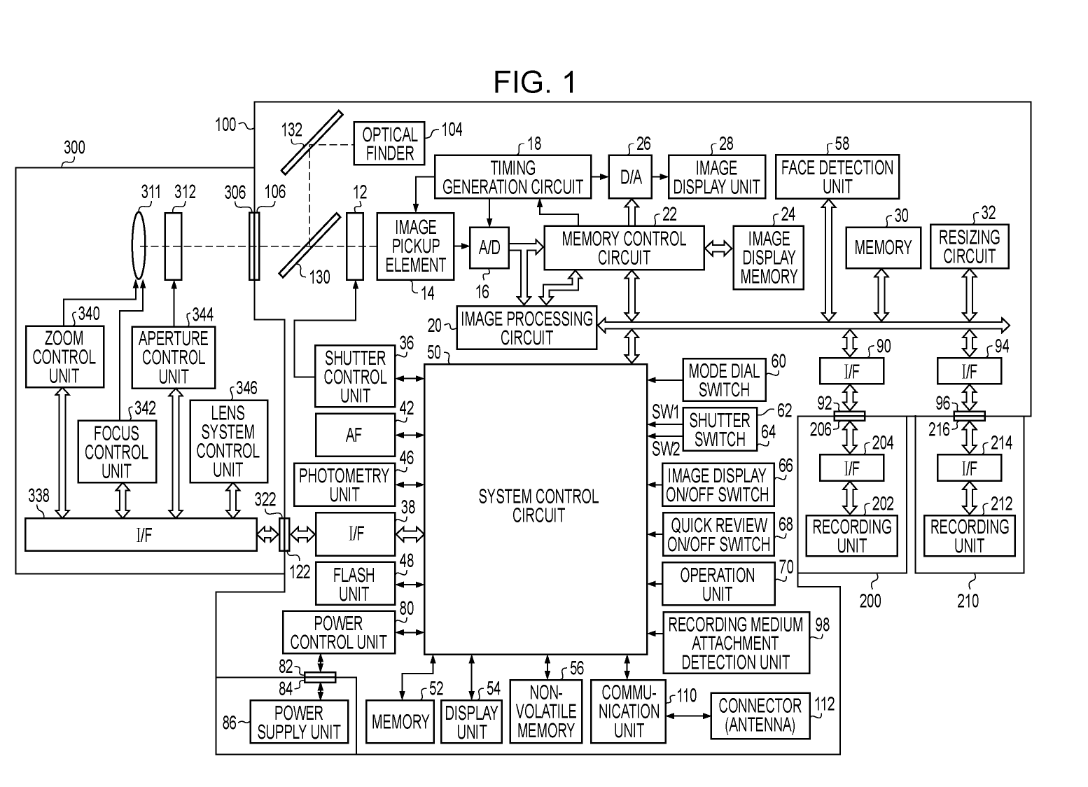

FIG. 1 is a block diagram illustrating a configuration of a digital still camera including replaceable lens according to a first exemplary embodiment of the present invention.

The digital still camera shown in FIG. 1 includes a camera body 100 and a replaceable lens unit 300 which is detachable from the camera body 100. Components of the camera body 100 and the replaceable lens unit 300 will be described hereinafter. A shutter 12 is used to control an amount of exposure for an image pickup element 14, the image pickup element 14 converts an optical image into an electric signal, and an A/D converter 16 converts an analog signal output from the image pickup element 14 into a digital signal (image data). A timing generation circuit 18 supplies clock signals and control signals to the image pickup element 14, the A/D converter 16, and a D/A converter 26 and is controlled using a memory control circuit 22 and a system control circuit 50.

An image processing circuit 20 performs predetermined pixel compensation processing and color conversion processing on image data supplied from the A/D converter 16 or the memory control circuit 22. Furthermore, the image processing circuit 20 performs a predetermined calculation processing using the image data. In accordance with a result of the calculation processing, the system control circuit 50 performs TTL (through-the-lens)-AF (autofocus) processing, AE (auto exposure) processing, and EF (flash preliminary light emission) processing on a shutter control unit 36, a focus control unit 342, and an aperture control unit 344, respectively. The image processing circuit 20 further performs TTL-AWB (auto white balance) in accordance with the result of the calculation processing.

A face detection unit 58 performs predetermined face detection processing on image data supplied from the image processing circuit 20 or the memory control circuit 22. The face detection processing performed using the face detection unit 58 is not limited to the above-described processing method, and any method may be employed as long as image data representing an object is subjected to the face detection processing.

The memory control circuit 22 controls the A/D converter 16, the timing generation circuit 18, the image processing circuit 20, an image display memory 24, the D/A converter 26, a memory 30, and a resizing circuit 32.

The A/D converter 16 transmits data through the image processing circuit 20 and the memory control circuit 22 or through only the memory control circuit 22 to the image display memory 24 or the memory 30.

Image data stored in the image display memory 24 are supplied through the D/A converter 26 to an image display unit 28 including a liquid crystal monitor which displays images corresponding to the image data.

The image display unit 28 successively displays the obtained image data whereby electronic finder function is realized. Furthermore, the image display unit 28 may enter a display-on mode or a display-off mode in accordance with an instruction supplied from the system control circuit 50. When the display-off mode is set, power consumption of the camera body 100 is considerably reduced.

The memory 30 stores still images and moving images, and has a storage capacity enough to store a predetermined number of still images and moving pictures obtained within a predetermined time period. Accordingly, even when a continuous shooting mode in which a plurality of still images are continuously shot or a panoramic shooting mode is entered, many images are stored in the memory 30 at high speed. Furthermore, the memory 30 serves as a workplace for the system control circuit 50.

The resizing circuit 32 resizes image data using adaptive discrete cosine transform (ADCT), for example. The resizing circuit 32 reads an image stored in the memory 30, performs resizing processing, and controls the memory 30 to store therein image data which has been subjected to the resizing processing.

The shutter control unit 36 controls the shutter 12 in accordance with photometry information supplied from a photometry unit 46 while operating collaboratively with the aperture control unit 344 which controls an aperture 312.

An interface 38 is included in a lens mount 106 and used to connect the replaceable lens unit 300 to the camera body 100. A connector 122 is used to electrically connect the replaceable lens unit 300 to the camera body 100.

An AF unit 42 performs AF processing. A light beam which is incident on a lens 311 is transmitted through the aperture 312, a lens mount 306, the lens mount 106, a mirror 130, and an AF sub-mirror (not shown) to the AF unit 42. Then, the AF unit 42 measures a focal state of an image formed as an optical image.

Note that the system control circuit 50 may perform exposure control processing and AF control processing on the shutter control unit 36, the focus control unit 342, and the aperture control unit 344 in accordance with the result of the calculation processing performed using the image processing circuit 20 on image data supplied from the image pickup element 14.

Furthermore, a result of the measurement performed using the AF unit 42 and the result of the calculation processing performed using the image processing circuit 20 on the image data supplied from the image pickup element 14 may be used together for the AF control processing.

The photometry unit 46 performs the AE processing. A light beam which is incident on the lens 311 is transmitted through the aperture 312, the lens mounts 306 and 106, the mirror 130, a mirror 132, and a photometry lens (not shown) to the photometry unit 46. Then, the photometry unit 46 measures a focal state of an image formed as an optical image.

The photometry unit 46 operates collaboratively with a flash unit 48 so as to perform EF processing.

The flash unit 48 has a floodlight function of emitting AF-supporting light and a flash modulation function.

The system control circuit 50 controls the entire camera body 100. A memory 52 stores constants, variables, and programs, for example, used in operation of the system control circuit 50.

A display unit 54 includes a liquid crystal display device and a speaker which are used to output operation states and messages by means of text, images, and sound in accordance with executions of the programs using the system control circuit 50. The display unit 54 is arranged in a portion or a plurality of display units 54 are arranged in portions which are located near the operation unit of the camera body 100 and which are easily viewed by a user. The display unit 54 is constituted by a combination of an LCD (liquid crystal display), an LED (light emitting diode), and a sound generating element, for example.

Note that an optical finder 104 includes some of functions of the display unit 54. The display unit 54 displays on the LCD, for example, information items about the number of shots such as the number of recorded images and the available number of shots, and information items about shooting conditions such as shutter speed, an aperture value, exposure compensation, and flash setting. In addition, the display unit 54 displays a remaining amount of battery, and a date and time. The optical finder 104 displays information items about a focal point, blur warning, an amount of flash-battery charging, the shutter speed, the aperture value, and the exposure compensation.

A nonvolatile memory 56, such as an EEPROM (electrically erasable and programmable read-only memory), electrically stores data therein, and the stored data is electrically erasable.

A mode dial switch 60, shutter switches 62 and 64, an image display on/off switch 66, a quick review on/off switch 68, and an operation unit 70 are included in an operation section, and are used to input various operation instructions to the system control circuit 50. Each of them is constituted by solely a switch, a dial, a touch panel, a pointing device employing a line-of-sight detection device, and a voice-recognition device or by a combination thereof.

The mode dial switch 60 is used to set a mode by switching various function modes such as a power-off mode, an auto-photographing mode, a manual-photographing mode, a panoramic-photographing mode, a macro-photographing mode, a reproducing mode, a multi-screen reproducing and erasing mode, and a PC-connection mode.

The shutter switch SW1 62 is turned on when a shutter button, not shown, is half pressed, and instructs starts of operations such as the AF processing, the AE processing, AWB (automatic white balance) processing, and the EF processing.

The shutter switch SW2 64 is turned on when the shutter button, not shown, is fully pressed, and instructs a start of a series of operations relating to photographing. The operations relating to photographing include exposure processing, development processing, and recording processing. In the exposure processing, a signal is supplied from the image pickup element 14 to the A/D converter 16 so as to be converted into image data, and the image data is supplied through the memory control circuit 22 to the memory 30. The development processing is performed through calculations performed in the image processing circuit 20 and the memory control circuit 22. In the recording processing, the image data is read from the memory 30, is compressed in the resizing circuit 32, and is written to a recording medium 200 or a recording medium 210.

The image display on/off switch 66 is used to set an on state or an off state of the image display unit 28. Accordingly, the image display on/off switch 66 shuts out current supplied to the image display unit 28 including the liquid crystal monitor when a photographing operation is performed using the optical finder 104 so that electrical power saving is attained.

The quick review on/off switch 68 is used to set a quick review function of automatically reproducing image data corresponding to captured images immediately after the photographing operation. Note that in this exemplary embodiment, the quick review function is performed when the image display unit 28 is turned off.

The operation unit 70 includes various buttons and a touch panel. The various buttons include a menu button, a flash setting button, a single-shot/continuous-shot/self-timer switching button, a selection moving button, a photographing-image-quality selection button, an exposure compensation button, and a date-and-time setting button.

A power control unit 80 includes a battery detection circuit, a DC/DC converter, and a switch circuit which is used to select a block to be brought into a conductive state. The power control unit 80 detects attachment of a battery, a type of the battery, and a remaining amount of the battery, controls the DC/DC converter in accordance with results of the detections and an instruction issued from the system control circuit 50, and supplies required voltages to the components including the recording media for a predetermined period of time.

Connectors 82 and 84 are also included in the camera body 100, and a power supply unit 86 includes a primary battery such as an alkali battery or a lithium battery or a secondary battery such as an NiCd battery, an NiMH battery, or an Li battery, and an AC adapter.

Interfaces 90 and 94 are provided for the recording media such as memory cards and hard disks. Connectors 92 and 96 are connected to the recording media such as memory cards and hard disks. A recording medium attachment detection unit 98 detects whether a recording medium is attached to one of the connectors 92 and 96.

Note that in this exemplary embodiment, two systems each including the interfaces and the connecters which are used for attachment of recording media are employed. However, a single system or a plurality of systems each including interfaces and connecters may be employed. Alternatively, an interface and a connecter which conform to different standards may be employed in combination. Furthermore, an interface and a connector which conform to a certain standard such as a standard of a PCMCIA (Personal Computer Memory Card International Association) card and a standard of a CF (Compact Flash) card may be employed.

Furthermore, image data and a management information item regarding the image data are transmitted and received between the digital still camera and a peripheral such as a computer or a printer by connecting a LAN (Local Area Network) card or various communication cards such as a modem card to the interfaces and connecters.

A light beam which is incident on the lens 311 is introduced into the optical finder 104 through the aperture 312, the lens mounts 306 and 106, and the mirrors 130 and 132. The optical finder 104 forms an optical image using the introduced light beam. In this way, the photographing operation may be performed only using the optical finder 104 without using an electronic finder function of the image display unit 28. Furthermore, the optical finder 104 includes some of the functions of the display unit 54 such as a focal point display function, a blur warning display function, a function of displaying an amount of flash-battery charging, a shutter speed display function, an aperture-value display function, and an exposure-compensation display function.

A communication unit 110 employs various communication technologies based on RS232C, USB, IEEE1394, P1284, and SCSI, a modem, a LAN, and a wireless communication.

A connector 112 is used to connect the camera body 100 to an external apparatus through the communication unit 110 or corresponds to an antenna in wireless communication.

The connector 122 is used for communication between the camera body 100 and the replaceable lens unit 300 so that control signals, state signals, and data signals, for example are transmitted and received. In addition, the connector 122 has a function of supplying currents of various voltages. Furthermore, the connector 122 may be used to perform not only electrical communication but also optical communication and audio communication, for example.

The mirrors 130 and 132 introduce a light beam incident on the lens 311 to the optical finder 104 by a single-lens reflex method. Note that the mirror 130 may be configured as a quick-return mirror or a half mirror. Furthermore, a configuration which does not include the mirrors 130 and 132, that is, a method different from the single-lens reflex method may be employed.

The recording media 200 and the 210 correspond to memory cards and hard disks. The recording medium 200 includes a recording unit 202, an interface 204 used for connection to the camera body 100, and a connector 206 used for connection to the camera body 100. The recording medium 210 includes a recording unit 212, an interface 214 used for connection to the camera body 100, and a connector 216 used for connection to the camera body 100.

The replaceable lens unit 300 is attachable to the camera body 100.

The lens mount 306 is used to mechanically couple the replaceable lens unit 300 to the camera body 100. The lens mount 306 includes various functions of electrically connecting the replaceable lens unit 300 to the camera body 100.

The lens 311 includes a focus lens used to control a focal point for an object.

A connector 322 is used to electrically connect the lens unit 300 to the camera body 100. An interface 338 is used to connect the lens unit 300 to the connector 122 of the camera body 100. The connector 322 is used to transmit and receive control signals, state signals, and data signals between the camera body 100 and the lens unit 300. In addition, the connector 322 has a function of receiving or supplying currents of different voltages. Note that the connector 322 may be used to perform not only electrical communication but also optical communication and audio communication, for example.

A zoom control unit 340 controls a zooming operation of the lens 311. The focus control unit 342 controls a focusing operation of the lens 311. Note that if the lens 311 is a single-focus lens which does not include a zooming function, the zoom control unit 340 may be omitted.

The aperture control unit 344 controls the aperture 312 while operating collaboratively with the shutter control unit 36 which controls the shutter 12 in accordance with photometry information supplied from the photometry unit 46.

A lens system control unit 346 controls the entire lens unit 300. The lens system control unit 346 functions as a memory which stores constants, variables, and programs, for example, which are used in operation of the lens unit 300. The lens system control unit 346 further functions as a nonvolatile memory which stores identifier information such as a unique number of the lens unit 300, function information such as management information, a maximum aperture value, a minimum aperture value, and a focal length, current-setting values, and past-setting values. Furthermore, the lens system control unit 346 may have a function of calculating a movement position information item, which will be described hereinafter.

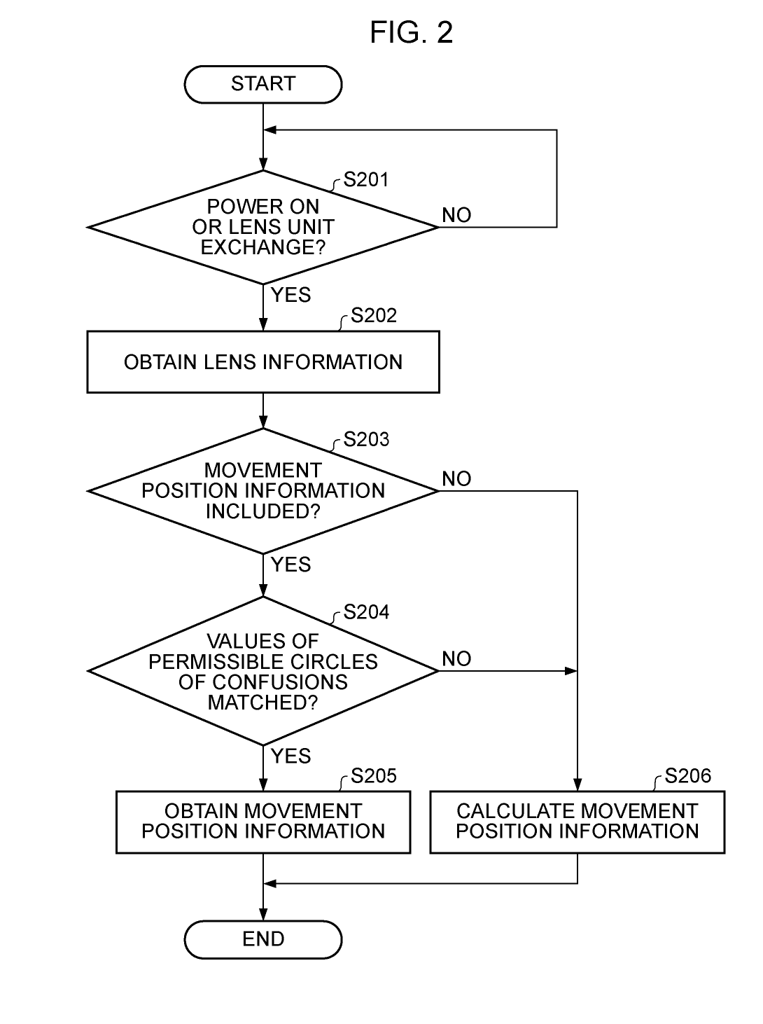

Referring now to a flowchart shown in FIG. 2, an operation of the camera body 100 of obtaining lens information and the movement position information item from the lens unit 300 will be described.

The movement position information item represents a position of the focus lens where the focus lens is located when image data to be subjected to the face detection processing is obtained. When the face detection processing is performed on the image data obtained when the focus lens is located in the position represented by the movement position information item, a face portion of an object in an image is successfully detected wherever the object is located within a range from a closest end to an infinite end. For example, when image data representing a certain object is obtained in a state in which the focus lens is moved to a certain movement position, an image corresponding to the image data is blur, and therefore, the face detection processing fails, whereas when image data representing the same certain object is obtained in a state in which the focus lens is moved to another movement position, the face detection processing is successfully performed. In this way, a face portion of the object is detected in an entire distance range which can be focused.

Note that the movement position information item is set in accordance with a depth of field. The depth of field is obtained by adding a front depth of field to a rear depth of field. The front and rear depths of field represent a portion of the depth of field corresponding to a front side of the object and a portion of the depth of field corresponding to a rear side of the object, respectively, viewed from the focus lens. The front and rear depths of field and the depth of field are obtained by the following equations:

Front Depth of Field=d×F×a²/(f²+d×F×a)

Rear Depth of Field=d×F×a²/(f²−d×F×a)

Depth of Field=Front Depth of Field+Rear Depth of Field

wherein, a reference character “d” denotes a permissible circle of confusion, a reference character “F” denotes an aperture value, a reference character “a” denotes an object distance, and a reference character “f” denotes a focal length. The permissible circle of confusion is determined by a cell pitch of the image pickup element 14 and calculated using a size of the image pickup element 14 and the number of pixels.

Now referring back to FIG. 2 wherein the flowchart illustrates operation of the system control circuit 50 when obtaining lens information from the lens unit 300.

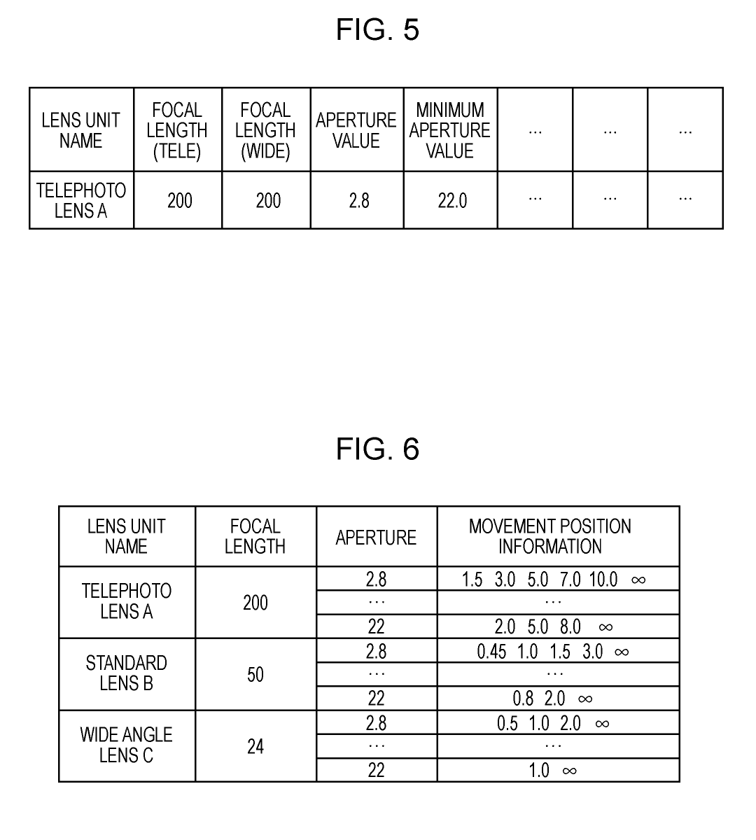

When the camera body 100 is turned on or replacement of the lens unit 300 is detected in step S201, the system control circuit 50 communicates with the lens unit 300 through the interface 38 and obtains lens information of the lens unit 300 as shown in FIG. 5 in step S202. The lens information includes a lens unique information item, a focal length, an aperture value, a movement position information item, and a permissible circle of confusion obtained when the movement position information item is set. As described above, in order to set the movement position information item, not only information on the lens unit 300 but also information on a permissible circle of confusion of the camera body 100 such as a cell pitch of the image pickup element 14 is required. Therefore, when the movement position information item is intended to be set in the lens unit 300 without using the information on the camera body 100, a preset value of the permissible circle of confusion is used.

It is determined whether the obtained lens information includes the movement position information item in step S203. When the determination is affirmative in step S203, the process proceeds to step S204 whereas when the determination is negative in step S203, the process proceeds to step S206. In step S204, it is determined whether the value of the permissible circle of confusion obtained when the movement position information item is set coincides with the value of the permissible circle of confusion of the camera body 100. Note that the value of the permissible circle of confusion of the camera body 100 is stored in the nonvolatile memory 56 in advance.

When the determination is affirmative in step S204, the process proceeds to step S205 where the system control circuit 50 controls the nonvolatile memory 56 to store the obtained movement position information item therein. On the other hand, when the determination is negative, the process proceeds to step S206 where the system control circuit 50 calculates an appropriate movement position information item using the obtained movement position information item and the value of the permissible circle of confusion of the camera body 100, and the calculated appropriate movement position information item is stored in the nonvolatile memory 56. The appropriate movement position information item may be calculated using the lens unit 300. In this case, the lens unit 300 communicates with the camera body 100 so as to obtain the value of the permissible circle of confusion, and controls the lens system control unit 346 to calculate the appropriate movement position information item from the movement position information item held in the lens unit 300 and the obtained value of the permissible circle of confusion. Then obtained movement position information item is supplied to the camera body 100 and stored in the nonvolatile memory 56.

When the determination is negative in step S203, the system control circuit 50 calculates the movement position information item from the obtained focal length, the aperture value, and the value of the permissible circle of confusion of the camera body 100, and the calculated movement position information item is stored in the nonvolatile memory 56. In this case also, the lens unit 300 may calculate the movement position information item.

Note that when the determination is negative in step S203, instead of the calculation performed for obtaining the movement position information item, a data table listing lens unique information items and movement position information items as shown in FIG. 6 may be provided in advance and a movement position information item corresponding to one of the lens unique information items may be read from the data table. In this case, since the movement position information items are stored in the data table, the face detection processing is performed using one of the movement position information items corresponding to an attached lens unit. In this case, the data table is stored in the nonvolatile memory 56.

Alternatively, a storage medium including the data table shown in FIG. 6 may be connected to the camera body 100, and one of the movement position information items corresponding to the lens unit attached to the camera body 100 and corresponding to the camera body 100 may be obtained from the data table so that the face detection processing is performed.

Note that, in the flowchart shown in FIG. 2, taking speed-up of the face detection processing at a time of a live-view mode into consideration, a sequence in which the movement position of the focus lens which is used for obtaining image data to be subjected to the face detection processing is obtained or calculated when the camera body 100 is turned on or the replacement of the lens unit 300 is detected is employed. However, the movement position of the focus lens may be obtained or calculated when the live-view mode is started, that is, a timing of obtaining the movement position of the focus lens is not limited. Similarly, a timing in which the lens information is obtained is not limited to a timing in which the camera body 100 is turned on or the replacement of the lens unit 300 is detected.

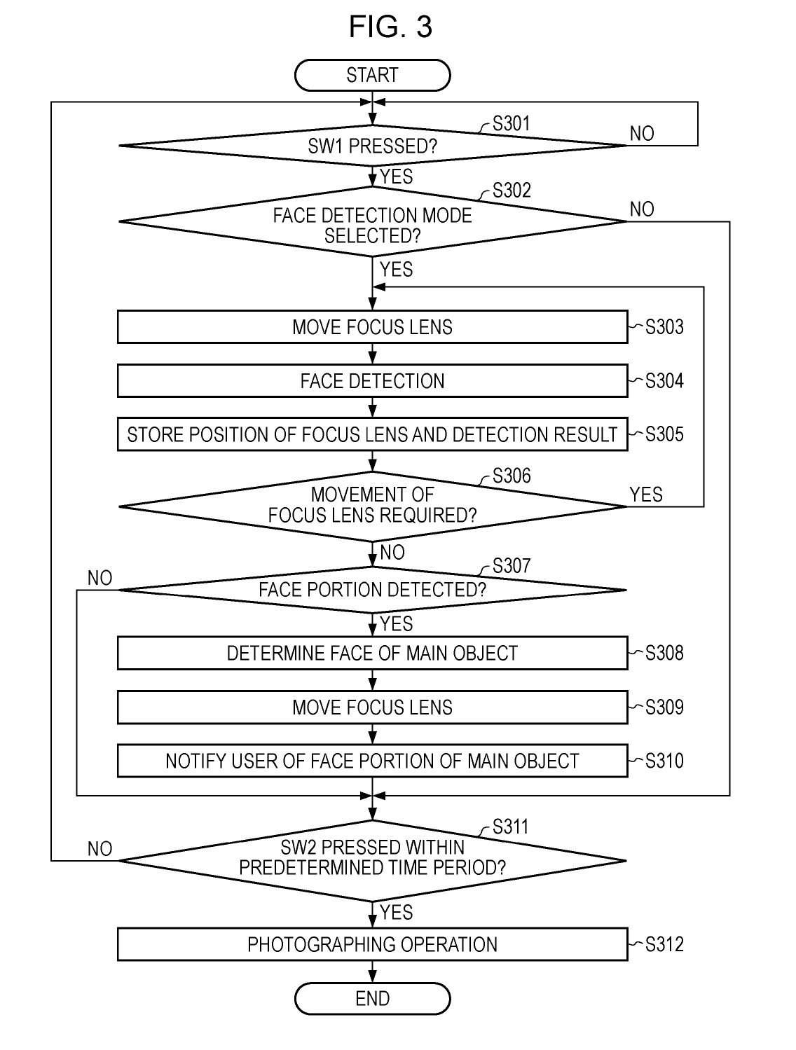

FIG. 3 shows a flowchart illustrating operation of face detection processing in a case where the image display unit 28 is used as an electronic finder (in a live-view mode).

Note that the operation described below is performed in an auto-photographing mode in which the camera automatically sets an appropriate function. In addition to the setting of the auto-photographing mode, setting of whether the face detection processing is performed may be performed. Note that it is assumed that a movement position information item corresponding to the lens unit 300 is obtained in advance.

In the live-view mode, when the system control circuit 50 determines that the shutter switch SW1 62 is turned on by half-pressing the shutter button in step S301, the process proceeds to step S302 where it is determined whether setting of performing of the face detection processing (hereinafter referred to as a “face detection mode”) is selected in step S302. When the determination is affirmative in step S302, the process proceeds to step S303 where the system control circuit 50 compares a current position of the focus lens with a movement position of the focus lens included in the movement position information item, and when difference is detected therebetween, the focus lens is moved to the movement position so as to obtain image data. After the image data is obtained, the face detection processing is performed using the face detection unit 58 on the obtained image data representing the object in step S304.

Then, a result of the face detection processing and information on the movement position of the focus lens located when the image data subjected to the face detection processing is obtained are stored in the nonvolatile memory 56 in step S305. Subsequently, in step S306, the system control circuit 50 determines whether the focus lens is required to be moved to another movement position. When another movement position of the focus lens which has not yet been subjected to the face detection processing is detected in the movement position information item corresponding to the lens unit 300, the focus lens is required to be moved to the detected movement position, and otherwise, the focus lens is not required to be moved for the face detection processing. When the determination is affirmative in step S306, the processes in step S303 to step S306 are repeatedly performed. When the determination is negative in step S306, the system control circuit 50 determines in step S307 whether a face portion is detected in the image data obtained when the focus lens is located in the movement position on the basis of the information items stored in the step S305.

In a case where only one movement position of the focus lens in which image data including a face portion is obtained is detected, the system control circuit 50 determines the face portion of a main object in accordance with a result of face detection processing performed on the image data. In a case where a plurality of movement positions of the focus lens where respective face portions are detected in images corresponding to image data are detected, the system control circuit 50 determines the face portion of the main object from the movement positions of the focus lens, sizes of the detected face portions, and positions of the face portions detected in the images in step S308. In step S309, the focus lens is moved to the movement position where the image data corresponding to the image including the face portion of the main object is detected. In step S310, the system control circuit 50 notifies the user of the face portion of the main object by means of a display method of adding a rectangular frame to the face portion of the main object displayed in the image display unit 28, for example.

When the system control circuit 50 determines that the shutter switch SW2 64 is turned on by fully-pressing the shutter button within a predetermined period of time in step S311, photographing processing is performed in step S312. When the shutter button is not fully pressed within the predetermined period of time, and therefore, the shutter switch SW2 64 is not turned on, the process returns to step S301 and the face detection processing is started over.

Note that in this flowchart, the AF processing, the AE processing, the AWB processing, and the EF processing, for example are omitted.

Although the setting in which the face detection processing is started over when the shutter button is not fully pressed within the predetermined period of time and therefore the shutter switch SW2 64 is not turned on is employed in this exemplary embodiment, the face detection processing may be prevented from being performed again while the shutter switch SW1 62 is turned on by half-pressing the shutter button.

Furthermore, although, in this exemplary embodiment, when the face detection mode is selected, the shutter button is half pressed so that the shutter switch SW1 62 is turned on before the face detection processing is performed, the face detection processing may be automatically performed in predetermined intervals in the live-view mode. In this case, when the focus lens is moved for the face detection processing, a focus point of the image in the live-view mode is also shifted, and therefore, an image in a live-view screen becomes blur. Accordingly, the face detection processing may be performed without moving the position of the focus lens.

Furthermore, in a case where a single object is intended to be continuously photographed several times, if the face detection processing is performed by moving the position of the focus lens every time the shutter button is half pressed so that shutter switch SW1 62 is turned on, a considerably large amount of time is required for the face detection processing, and therefore, the user may miss good shots. Therefore, the face detection processing may be performed without changing the position of the focus lens when the face portion of the object is appropriately focused.

Moreover, when a plurality of face portions are detected, the user may arbitrary select one of the face portions of the main object.

In this exemplary embodiment, the face portion which is determined to be the face portion of the main object is notified to the user. However, in a case where a plurality of face portions are detected other than the face portion of the main object, the plurality of face portions other than the face portion of the main object may be notified to the user so that the user can distinguish between the face portion of the main object and the plurality of face portions.

Although only the operation in the auto-photographing mode is described in this exemplary embodiment, any other photographing modes may be employed as long as the face detection processing is effectively performed.

The face detection processing may not be performed even when the face detection mode is selected, in a case where a photographing mode in which the face detection processing is not required to be performed, such as a macro photographing mode or a scenery photographing mode, is selected.

According to the flowchart shown in FIG. 3, the camera body 100 controls the position of the focus lens. However, the lens unit 300 may control the position of the focus lens. In this case, when the lens unit 300 determines that the shutter button is half pressed and the face detection mode is selected through the communication with the camera body 100, the lens unit 300 controls the focus lens to be moved to the movement position in accordance with the movement position information item. Specifically, the lens system control unit 346 controls the focus control unit 342 to move the focus lens to a position indicated by the movement position information item. When the movement position information item is stored in the lens unit 300, the movement position information item included in the lens unit 300 is used whereas when the movement position information item is not stored in the lens unit 300, the movement position information item obtained through the communication with the camera body 100 is employed. When the movement position information item is stored in the lens unit 300, a value of a permissible circle of confusion is obtained through the communication with the camera body 100, and the processes in step S204 to step S206 shown in FIG. 2 are performed. The obtained movement position information item or calculated movement position information item is stored in the lens system control unit 346.

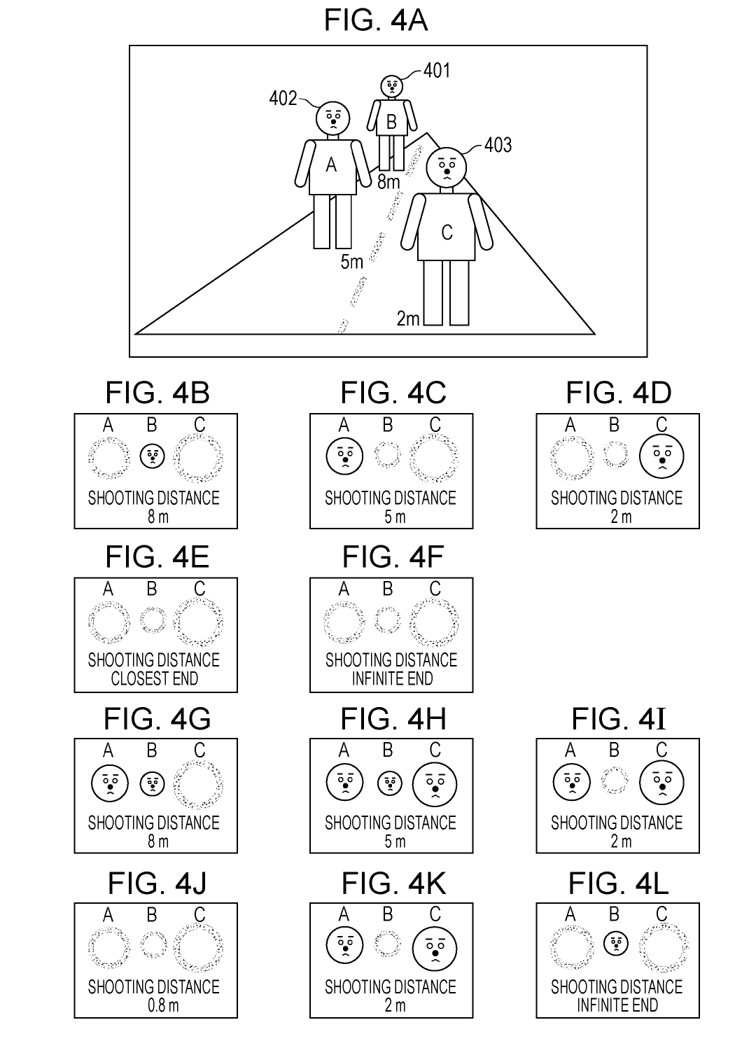

Referring now to FIGS. 4A to 4L, results of face detection processing obtained by changing a movement position of the focus lens when a depth of field is changed will be described.

FIGS. 4B to 4F show results of face detection processing performed on an image including images of Mr. A, Mr. B and Mr. C as objects. According to an image shown in FIG. 4A, Mr. A, Mr. B, and Mr. C are standing in positions 5 m (402), 8 m (401), and 2 m (403) away from the user, respectively. Photographing operation is performed so that these images corresponding to three people are included in a single image.

A telephoto lens A which has a small depth of field and a long focal length as shown in FIG. 6 is employed as the lens unit 300 in the photographing operation.

When image data is obtained in a state in which the telephoto lens A is attached to the camera body 100 and the focus lens is moved so that the position where Mr. B is standing is focused, that is, a position 8 m away from the user is focused, face portions of Mr. A and Mr. C in the image become blur and are not appropriately detected due to the small depth of field as shown in FIG. 4B. On the other hand, when image data is obtained in a state in which the focus lens is moved so that the position where Mr. A is standing is focused, that is, a position 5 m away from the user is focused, the face portion of Mr. B and a face portion of Mr. C in the image become blur and are not appropriately detected due to the small depth of field as shown in FIG. 4C. Furthermore, when image data is obtained in a state in which the focus lens is moved so that the position where Mr. C is standing is focused, that is, a position 2 m away from the user is focused, the face portions of Mr. A and Mr. B in the image become blur and are not appropriately detected due to the small depth of field as shown in FIG. 4D. When image data is obtained in a state in which the focus lens is moved so that a closest end is focused, the face portions of Mr. A, Mr. B, and Mr. C in the image become blur and are not appropriately detected due to the small depth of field as shown in FIG. 4E. When image data is obtained in a state in which the focus lens is moved so that an infinite end is focused, the face portions of Mr. A, Mr. B, and Mr. C in the image become blur and are not appropriately detected due to the small depth of field as shown in FIG. 4F.

Accordingly, even when the focus lens is moved in any position, the face portions of the three people are not simultaneously detected from the single image corresponding to the image data.

To address this disadvantage, an aperture value of F22 is set to the telephoto lens A in the photographing operation, and the face detection processing is performed on the image data obtained in the states in which the focus lens is moved so that the positions 2.0 m, 5.0 m, and 8.0 m away from the user and the infinite end are focused. By this, the face portions of the three people, i.e., three objects shown in FIG. 4A are detected. In this case, even when another object is located in a position closer than the position of Mr. C or in a position farther than the position of Mr. B, a face portion of the object is detected using one of the obtained image data.

In general, a large aperture value is selected so that a large depth of field is obtained in order to reduce the number of movement positions of the focus lens in the face detection processing and the number of times the face detection processing is performed. However, for example, when a photographing operation is performed at home or when a night scene is shot, a large aperture value is not appropriate taking an adverse effect on an image to be obtained into consideration. To address this disadvantage, a case where the telephoto lens A is attached to the camera body 100 and an aperture value of F2.8 is selected will be described as an example. In this case, face detection processing is performed using image data obtained in the states in which the focus lens is moved so that the five positions 1.5 m, 3.0 m, 5.0 m, 7.0 m, and 10.0 m away from the user and the infinite end, that is, the six positions, are focused. By this, the face portions of the three people, i.e., three objects shown in FIG. 4A are detected. In this case, even when another object is located in a position closer than the position of Mr. C or in a position farther than the position of Mr. B, a face portion of the object is detected using one of the obtained image data.

As described above, an optimum movement position of the focus lens used when image data to be subjected to the face detection processing is obtained by changing the movement position of the focus lens in accordance with the change of the aperture value. In this way, the face detection processing is successfully performed on all distance range which can be focused from the closest end to the infinite end, and the number of movement positions of the focus lens when the face detection processing is performed, the number of times the face detection processing is performed, and a period of time required for the face detection processing are reduced.

When a plurality of face portions are detected as described above, a face portion of a main object is selected from among the detected plurality of face portions. The face portion of the main object is arbitrary selected by the user or is selected in accordance with a movement position of the focus lens where an image including the face portion is obtained, a size of the detected face portion, and a position of the detected face portion in the captured image. Then, focus control is performed and an amount of exposure is compensated for in accordance with the selected face portion of the main object, and the desired main object is photographed with an optimum photographing parameter with high accuracy and at high speed.

FIGS. 4G to 4L show results of face detection processing performed on an image including images of Mr. A, Mr. B and Mr. C as objects. Note that the results shown in FIGS. 4B to 4F are obtained using the telephoto lens A whereas the results shown in FIGS. 4G to 4L are obtained using a standard lens B. The standard lens B has a smaller focal length and a larger depth of field when compared with those of the telephoto lens A as shown in FIG. 6.

When image data is obtained in a state in which the standard lens B is attached to the camera body 100 and a focus lens is moved so that the position where Mr. B is standing is focused, that is, the position 8 m away from the user is focused, the face portion of Mr. A in the image is detected but the face portion of Mr. C in the image becomes blur and is not detected due to the large depth of field as shown in FIG. 4G. On the other hand, when image data is obtained in a state in which the focus lens is moved so that the position where Mr. A is standing is focused, that is, a position 5 m away from the user is focused, the face portions of Mr. B and Mr. C in the image are detected due to the large depth of field as shown in FIG. 4H. Furthermore, when image data is obtained in a state in which the focus lens is moved so that the position where Mr. C is standing is focused, that is, a position 2 m away from the user is focused, the face portion of Mr. A in the image is detected but the face portion of Mr. B in the image becomes blur and is not detected due to the large depth of field as shown in FIG. 4I.

Accordingly, the face portions of the three people are detected from the image data obtained in the state in which the focus lens is moved so that the position 5 m away from the user is focused.

However, although a distance between the user and the object located in the position closest to the user is 2 m and a distance between the user and the object located in the position farthest from the user is 8 m as shown in FIG. 4A, another object may be located in a position within the distance of 2 m or may be located in a position farther than the distance of 8 m. In this case, the face portions of all the objects are not necessarily detected when the focus lens is located in a fixed position.

In addition, in a case where the focal length of the lens unit 300 is small, when image data is obtained in a state in which the focus lens is moved to a position the same as a position for a lens having a large focal length, face detection processing may be performed several times on an identical face portion. That is, as shown in FIGS. 4G to 4I, after a face portion is detected in first image data, the identical face portion is further detected in second image data, which leads to waste of time.

To address this disadvantage, when an aperture value of F22 is set to the standard lens B in the photographing operation, the face detection processing is performed on the image data obtained in the states in which the focus lens is moved so that three positions, that is, positions 0.8 m and 2.0 m away from the user and the infinite end, are focused. By this, as shown in FIGS. 4J to 4L, identical face portions are not detected in different image data. In this case, even when another object is located in a position closer than the position of Mr. C or in a position farther than the position of Mr. B, a face portion of the object is detected using one of the obtained image data.

Note that, even when the movement position of the focus lens is optimized, a face portion of an image corresponding to an identical object may be detected several times in accordance with a position where the object is located.

As described above, an optimum movement position of the focus lens used when image data to be subjected to the face detection processing is obtained by changing the movement position of the focus lens in accordance with the change of the focal length. In this way, the face detection processing is successfully performed on all distance range which can be focused from the closest end to the infinite end, and the number of movement positions of the focus lens when the face detection processing is performed, the number of times the face detection processing is performed, and a period of time required for the face detection processing are reduced.

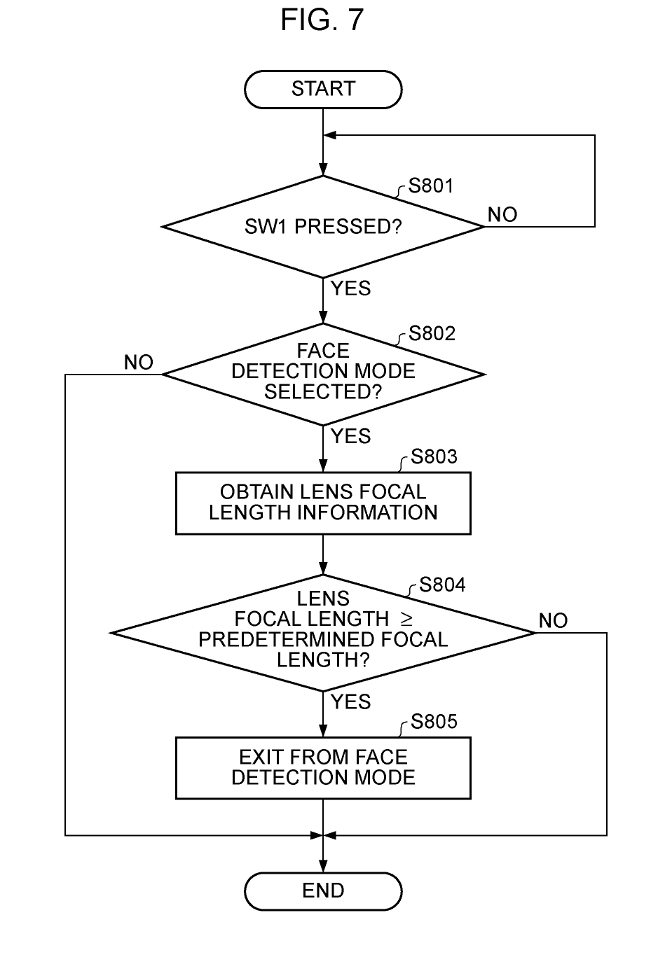

Referring now to a flowchart shown in FIG. 7, a method for controlling not to perform face detection processing when the focal length of the lens unit is equal to or larger than a predetermined focal length will be described.

In a case where the focal length of the lens unit is considerably large, even when the movement position of the focus lens is set in accordance with the movement position information item, a number of movement positions are obtained, and accordingly, a considerably large amount of time is required for the face detection processing. To address this disadvantage, when the focal length of the photographing lens is equal to or larger than a predetermined focal length, the face detection processing is not performed so that the user does not miss good shots.

FIG. 7 shows the operations performed in step S301 to step S303. In the live-view mode, when the shutter button is half pressed in step S801, it is determined whether the face detection mode is selected in step S802. When the determination is affirmative in step S802, the process proceeds to step S803 where the camera body 100 communicates with the lens unit 300 so as to obtain lens focal length information. As with the lens information shown in FIG. 5, the lens focal lens information is not limited to particular information as long as a focal length of the lens unit is obtained. Furthermore, when the camera body 100 has obtained information on the focal length of the lens through the communication with the lens unit 300, the camera body 100 is not required to communicate again with the lens unit 300.

In step S804, the lens focal length information obtained in step S803 is compared with a predetermined focal length stored in advance in the nonvolatile memory 56. When the focal length of the lens unit 300 is equal to or larger than the predetermined focal length, the face detection mode is exited in step S805. On the other hand, when the focal length of the lens unit 300 is smaller than the predetermined focal length, the face detection mode is not exited and operation of the face detecting mode is continued. Note that, when the lens unit 300 corresponds to a zoom lens, since the focal length thereof is arbitrarily changed within a predetermined range, it is difficult to compare the focal length of the lens unit 300 with the predetermined focal length. Therefore, the focal length of the lens unit 300 is compared with the predetermined focal length on the basis of a focal length in which user desired to use in the photographing operation, for example, a focal length obtained when the shutter button is half pressed.

Note that, in the flowchart shown in FIG. 7, the face detection processing is not performed when the focal length of the lens unit 300 is equal to or larger than the predetermined focal length. However, the face detection processing may not be performed when the number of movement positions of the focus lens indicated by the movement position information item is larger than the predetermined number.

Furthermore, when the focal length of the lens unit 300 is considerably large, it is thought that the user photographs an object located in a position away from the user to some extent. Therefore, when the focal length of the lens unit is equal to or larger than the predetermined focal length, instead of the exit of the face detection mode, a range within which the face detection processing is to be performed may be limited to a specific range. For example, the face detection processing may not be performed in a range from the closest end to a predetermined photographing position.

On the other hand, when the focal length of the lens unit is smaller than the predetermined focal length, it is thought that the user merely photographs an object located in a position considerably away from the user. Therefore, when the focal length of the lens unit is smaller than the predetermined focal length, the face detection processing may not be performed in a range from a predetermined photographing position to the infinite end.

As described above, since the range within which the face detection processing is to be performed is limited to the specific range in accordance with the focal length of the lens unit 300, the time required for face detection processing is reduced and the user does not miss good shots.

Note that, although in this exemplary embodiment, cases where the telephoto lens A and the standard lens B are used as the lens unit 300 for the photographing operations are described, any other lens such as a wide-angle lens or a zoom lens may be employed. The focal lengths of the telephoto lens A and the standard lens B are also not limited to the values shown in FIG. 6.

### Second Exemplary Embodiment

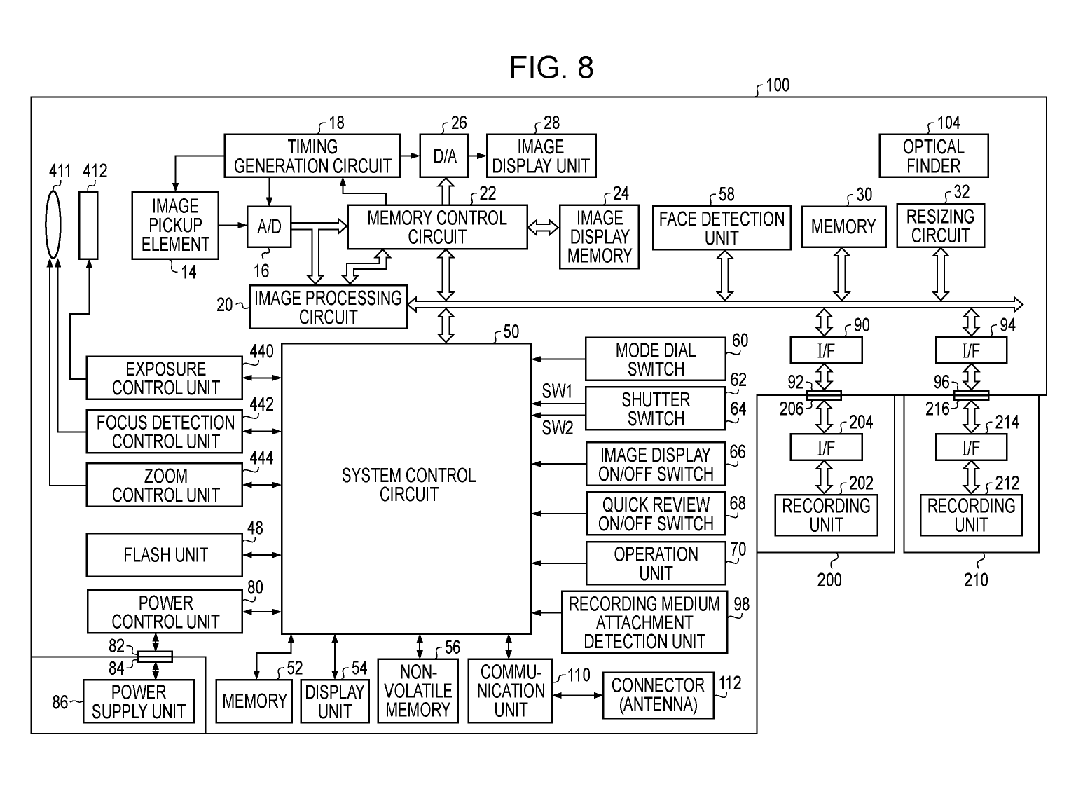

FIG. 8 is a diagram illustrating a configuration of a lens-integrated digital still camera according to a second exemplary embodiment of the present invention.

In FIG. 8, components similar to those of the configuration of FIG. 1 are denoted by reference numerals similar to those shown in FIG. 1, and therefore, descriptions thereof are omitted. A photographing lens 411 includes a focus lens and a zoom lens. A shutter 412 has an aperture function. An exposure control unit 440 controls the shutter 412 having the aperture function, and operates collaboratively with a flash unit 48 so as to have a flash modulation function. A focus detection control unit 442 controls a focusing operation of the photographing lens 411. A zoom control unit 444 controls a zooming operation of the photographing lens 411.

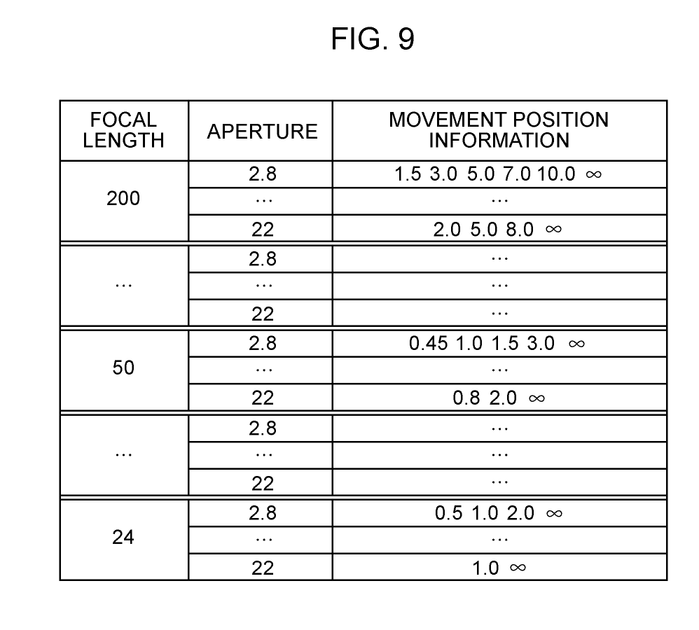

The second exemplary embodiment is different from the first exemplary embodiment in that a photographing optical system having a lens and an aperture is included in a main body of an image pickup apparatus, that is, the lens-integrated digital still camera. Therefore, the processing shown in FIG. 2 is not performed. Instead, a movement position information item is calculated using a system control circuit 50 in accordance with a focal length of the photographing lens 411 and an aperture value of the shutter 412. Alternatively, a data table shown in FIG. 9 including movement position information items corresponding to focal lengths and aperture values may be stored in a nonvolatile memory 56.

Operation of face detection processing is performed similar to the face detection processing in the flowchart shown in FIG. 3. Note that when the movement position information item is calculated in accordance with the focal length of the photographing lens 411 and the aperture value of the shutter 412, the focal length and the aperture value detected when the shutter button is half pressed in step S301 are employed. Furthermore, also in a case where the data table including movement position information items is used, one of the movement position information items corresponding to the focal length and the aperture value detected when the shutter button is half pressed in step S301 is read.

Note that the second exemplary embodiment and the first exemplary embodiment are different from each other in that the lens-integrated digital still camera is used in the second exemplary embodiment and the digital still camera including replaceable lens is used in the first exemplary embodiment. Therefore, the results shown in FIG. 4B to 4L are obtained as results of the face detection processing also in the second exemplary embodiment.

Furthermore, as with the first exemplary embodiment, in a case where a range to be subjected to the face detection processing is limited in accordance with a focal length, the range is limited in accordance with a focal length obtained when it is determined the shutter button is half pressed in step S301.

As described above, an optimum movement position of the focus lens used when image data to be subjected to the face detection processing is obtained by changing the movement position of the focus lens in accordance with the change of the aperture value. In this way, the face detection processing is successfully performed on all distance range which can be focused from the closest end to the infinite end, and the number of movement positions of the focus lens when the face detection operation is performed, the number of times the face detection operation is performed, and a period of time required for the face detection operation are reduced.

Furthermore, an optimum movement position of the focus lens used when image data to be subjected to the face detection processing is obtained by changing the movement position of the focus lens in accordance with the change of the focal length. In this way, the face detection processing is successfully performed on all distance range which can be focused from the closest end to the infinite end, and the number of movement positions of the focus lens when the face detection processing is performed, the number of times the face detection processing is performed, and a period of time required for the face detection processing are reduced.

Moreover, since a range within which the face detection processing is performed is limited to the specific range in accordance with the focal length of the photographing lens 411, the time required for face detection processing is reduced and the user does not miss good shots.

The exemplary embodiments of the present invention are implemented by supplying a recording medium including program codes of software which implement the functions of the foregoing two exemplary embodiments to the apparatus, and reading and executing the program codes recorded in the recording medium using a CPU included in a system or the apparatus. In this case, the program codes read from the recording medium implement the functions of the foregoing exemplary embodiments, and therefore, the recording medium including the program codes is included in the present invention. Furthermore, it is apparent that a case where an operating system, for example, which operates in a computer performs a portion of or entire processing in accordance with instructions of the program codes so that the functions of the foregoing exemplary embodiments are implemented is included in the present invention. Examples of the recording medium including the program codes include a flexible disk, a hard disk, a ROM (Read-Only Memory), a RAM (Random Access Memory), a magnetic tape, a nonvolatile memory card, a CD-ROM (Compact Disc Read-Only Memory), a CD-R (Compact Disc Recordable), a DVD (Digital Versatile Disc), an optical disc, and an MO (Magneto-Optical Disc). In addition, a computer network such as a LAN (Local Area Network) or a WAN (Wide Area Network) may be used for supplying the program codes.

Note that although the digital still cameras are taken as the examples in the foregoing exemplary embodiments, the present invention is applicable to digital video cameras, for example, as long as the image pickup devices have units configured to detect face portions of images corresponding to persons as objects in obtained image data.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions. This application claims the benefit of Japanese Application No. 2007-230404 filed Sep. 5, 2007, which is hereby incorporated by reference herein in its entirety.

What is claimed is:

1. An image pickup apparatus which obtains image data corresponding to an image formed using an imaging optical system including a focus lens, the image pickup apparatus comprising:
a face detection unit configured to detect a face portion of an object in image data obtained by moving the focus lens to a plurality of movement positions; and
a changing unit configured to change a movement position where the focus lens is located when image data to be subjected to face detection processing using the face detection unit is obtained in accordance with a change of a depth of field.

2. The image pickup apparatus according to claim 1,
wherein the changing unit changes the number of movement positions where the focus lens is located when the image data to be subjected to the face detection processing is obtained in accordance with the change of the depth of field.

3. The image pickup apparatus according to claim 1, further comprising:
a storage unit configured to store a plurality of movement positions of the focus lens set in accordance with the depth of field,
wherein the changing unit changes the movement position where the focus lens is located when the image data to be subjected to the face detection processing is obtained to one of the movement positions of the focus lens stored in the storage unit.

4. The image pickup apparatus according to claim 1,
wherein the changing unit changes the movement position where the focus lens is located when the image data to be subjected to the face detection processing is obtained using the face detection unit, in a case where at least one of a focal length and an aperture value of the imaging optical system is changed.

5. The image pickup apparatus according to claim 1,
wherein the image pickup apparatus includes a main body of the image pickup apparatus and a lens unit which is replaceable and attached to the main body of the image pickup apparatus and which includes the focus lens, and the lens unit includes the changing unit.

6. The image pickup apparatus according to claim 1,
wherein the face detection unit does not perform the face detection processing when a focal length of the imaging optical system is equal to or larger than a predetermined focal length.

7. The image pickup apparatus according to claim 1,
wherein the face detection unit does not perform the face detection processing in a range from a closest end to a predetermined shooting distance when a focal length of the imaging optical system is equal to or larger than a predetermined focal length.

8. The image pickup apparatus according to claim 1,
wherein the face detection unit does not perform the face detection processing in a range from a predetermined shooting distance to an infinite end when a focal length of the imaging optical system is smaller than a predetermined focal length.

9. An image pickup apparatus which obtains image data corresponding to an image formed using an imaging optical system including a focus lens, the image pickup apparatus comprising:
a face detection unit configured to detect a face portion of an object in image data obtained by moving the focus lens to a plurality of movement positions; and
a changing unit configured to change the number of times face detection processing is performed using the face detection unit in a range from a position of a first shooting distance to a position of a second shooting distance.

10. The image pickup apparatus according to claim 9,
wherein the changing unit changes the number of times the face detection processing is performed using the face detection unit in the range from the position of the first shooting distance to the position of the second shooting distance, in a case where at least one of a focal length and an aperture value of the imaging optical system is changed.

11. The image pickup apparatus according to claim 9,
wherein the position of the first shooting distance corresponds to a closest end and the position of the second shooting distance corresponds to an infinite end.

12. The image pickup apparatus according to claim 9,
wherein the image pickup apparatus includes a main body of the image pickup apparatus and a lens unit which is replaceable and attached to the main body of the image pickup apparatus and which includes the focus lens, and the lens unit includes the changing unit.

13. The image pickup apparatus according to claim 9,
wherein the face detection unit does not perform the face detection processing when a focal length of the imaging optical system is equal to or larger than a predetermined focal length.

14. The image pickup apparatus according to claim 9,
wherein the face detection unit does not perform the face detection processing in a range from a closest end to a predetermined shooting distance when a focal length of the imaging optical system is equal to or larger than a predetermined focal length.

15. The image pickup apparatus according to claim 9,
wherein the face detection unit does not perform the face detection processing in a range from a predetermined shooting distance to an infinite end when a focal length of the imaging optical system is smaller than a predetermined focal length.

16. A lens unit comprising:
a focus lens;
a connection unit configured to be connected to an image pickup apparatus which includes a face detection unit configured to detect a face portion of an object in image data obtained by moving the focus lens included in the lens unit to a plurality of movement positions; and
a changing unit configured to change a movement position where the focus lens is located when an image data to be subjected to face detection processing using the face detection unit is obtained in accordance with a change of a depth of field.

17. A lens unit comprising:
a focus lens;
a connection unit configured to be connected to an image pickup apparatus which includes a face detection unit configured to detect a face portion of an object in image data obtained by moving the focus lens included in the lens unit to a plurality of movement positions; and
a changing unit configured to change the number of times face detection processing is performed using the face detection unit in a range from a position of a first shooting distance to a position of a second shooting distance.

18. A face detection method performed by obtaining an image data corresponding to an image formed using an imaging optical system including a focus lens, the face detection method comprising:
detecting a face portion of an object in image data obtained by moving the focus lens included in the lens unit to a plurality of movement positions; and
changing a movement position where the focus lens is located when an image data to be subjected to face detection processing using the face detection unit is obtained in accordance with a change of a depth of field.

19. A face detection method performed by obtaining an image data corresponding to an image formed using an imaging optical system including a focus lens, the face detection method comprising:
detecting a face portion of an object in image data obtained by moving the focus lens included in the lens unit to a plurality of movement positions; and
changing the number of time face detection processing is performed using the face detection unit in a range from a position of a first shooting distance to a position of a second shooting distance.
